(19) United States
(12) Patent Application Publication
(10) Pub. No.: US 2007/0283050 A1
(43) Pub. Date: Dec. 6, 2007

(54) Scheduling reporting of synchronization states

(75) Inventor: James A. Savage, San Jose, CA (US)

Correspondence Address: HENSLEY KIM & HOLZER, LLC, 1660 LINCOLN STREET, SUITE 3000, DENVER, CO, 80264, US

(73) Assignee: Seagate Technology, LLC

(21) Appl. No.: 11/446,635

(22) Filed: Jun. 5, 2006

(51) Int. Cl. G06F 17/30; G06F 15/16; G06F 12/00

(52) U.S. Cl. 709/248; 707/201

(57) ABSTRACT

A synchronization system schedules the reporting of synchronization states between a synchronization client computing device and a synchronization server appliance device, based on relevant events in the synchronization process. A file system hierarchy is built by a scanning module based on recursive scanning of the file system on the synchronization client computing device. Events are detected by a file system watcher function and announced to the scanning module via an event queue. If a file state change is detected, the scanning module creates a synchronization report describing the file state change and schedules transmission of the synchronization report to the synchronization server appliance device, dependent on a prior action (e.g., a last file state change for the file, the last synchronization or upload time, the last reporting time, etc.).

### BACKGROUND

Existing applications are capable of synchronizing files between two systems, such as a client computing device and a server appliance device used for real-time backups and/or file sharing. When a file changes (e.g., is added, deleted, or modified) on one device, applications on the client and the server support the updating of the other device so that the states of the files on each device are synchronized. However, the applications can overwhelm the processors and storage subsystems on each device, as well as communications bandwidth between them, if the synchronization and associated operations are not managed carefully.

### SUMMARY

Implementations described and claimed herein address the foregoing problems by scheduling the reporting of synchronization states between a synchronization client computing device and a synchronization server appliance device, based on relevant events in the synchronization process. A file system hierarchy is built based on recursive scanning of the file system on the synchronization client computing device. Events are detected by a file system watcher function and announced to a scanning module via an event queue. If a file state change is detected, a synchronization report describing the file state change is scheduled for transfer (e.g., transmission) to the synchronization server appliance device, dependent on timing of a prior action (e.g., a last file state change for the file, the last synchronization or upload time, the last reporting time, etc.).

In some implementations, articles of manufacture are provided as computer program products. One implementation of a computer program product provides a computer program storage medium readable by a computer system and encoding a computer program. Another implementation of a computer program product may be provided in a computer data signal embodied in a carrier wave by a computing system and encoding the computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example synchronization system.

FIG. 2 illustrates an example architecture for a synchronization client.

FIG. 3 illustrates example operations for populating a file system object hierarchy.

FIG. 4 illustrates example operations for handling file change events.

FIG. 5 illustrates example operations for scheduling transmission of a synchronization report.

FIG. 6 illustrates an example system that may be useful in implementing the described technology.

### DETAILED DESCRIPTION

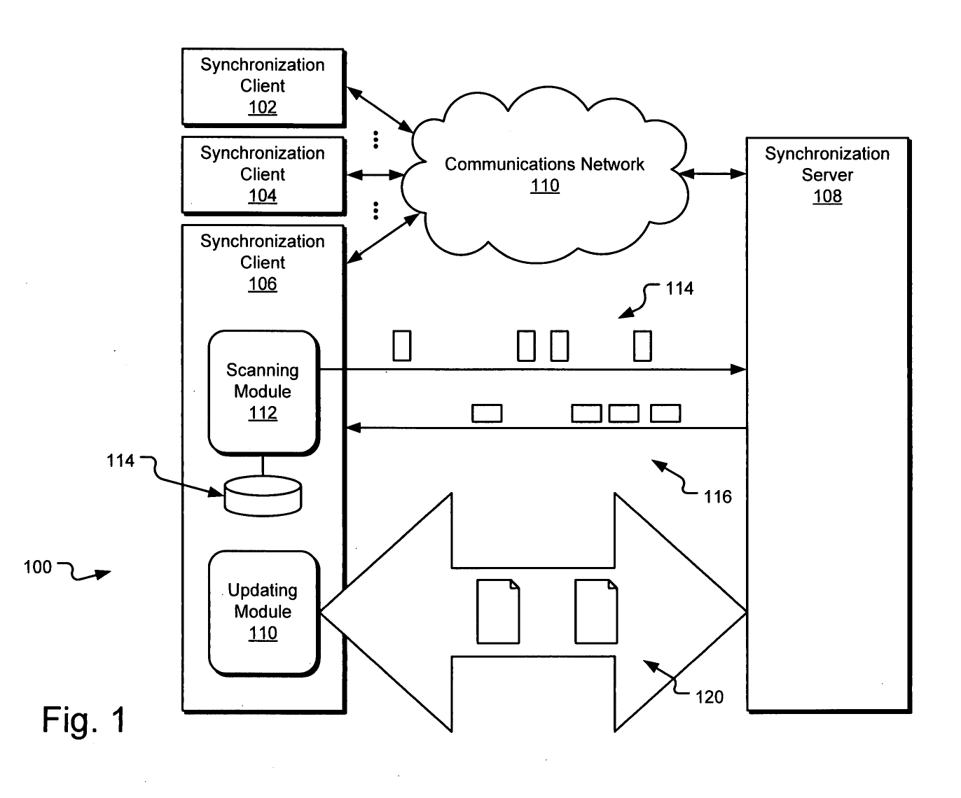

FIG. 1 illustrates an example synchronization system 100. Multiple synchronization clients 102, 104, and 106 are coupled to a synchronization server 108 via a network 110 or another communications channel, such as FireWire (IEEE 1394), USB (Universal Serial Bus), RS232 (serial channel), etc. It should be understood that a synchronization system may include any number of synchronization clients (e.g., one, two, or more), and that three synchronization clients are shown merely as an example. In addition, a synchronization client may be coupled to multiple synchronization servers.

A synchronization client 106 maintains a file system, which is configured to be synchronized with data stored on the synchronization server 108. In this way, for example, the synchronization server 108 can provide backup storage capabilities for the synchronization client 106, such that the synchronization client 106 can recover from a loss of data (e.g., a hard disk crash or an inadvertent file deletion) by restoring the data from the synchronization server 108. Likewise, if more than one synchronization client is coupled to the synchronization server 108, then data on any client can be shared with other clients via the synchronization server 108.

The synchronization client 106 is shown as including a scanning module 112, which maintains a synchronization state datastore 114. The synchronization state datastore 114 records synchronization state of files of the synchronization client 106 and the synchronization server 108. Using the synchronization state datastore 114, the synchronization client 106 can determine which files to upload from the synchronization server 118 in an updating stage of synchronization.

In one implementation, the synchronization client 106 maintains a synchronization state datastore 114 as an array of folder objects. A folder object is associated with a folder in the file system of the synchronization client 106 (and therefore the corresponding folder in the file system of the synchronization server 108) and maintains a database of the file objects associated with files in each folder. A file object maintains the synchronization state of the associated file. An example synchronization state for a file may be represented by the following fields of a file or folder object, although other state representations may be employed:
Unreported state—set to add, delete, or edit when a file change event is detected; reset to none when synchronization client reports the state of the file to the synchronization server
Reported state—set to add, delete, or edit when a new state report for the file is sent to the synchronization server; reset to none when synchronization client receives a confirmation of the synchronization server's state for this file
Confirmed state—set to add, delete, or edit when the synchronization client receives a confirmation of the synchronization server's state for this file, based on the file state on the synchronization server.
NextReport—set to the “next report time” or when a transmission of a synchronization report for the associated to the synchronization server is scheduled; reset when the synchronization report has been transferred to the synchronization server
File—the name of the file associated with the watch object
FullPath—the path name in the file system of the file associated with the watch object
LastUploadTime—the time of the last upload of the changed file to the synchronization server
LastUploadSize—the amount of data in the last upload of the changed file to the synchronization server
LastWriteTime—the last time the file was edited on the client (also referred to as the last file change time)

For example, data in a watch object for a given file may include the following fields and values:

File Name=“e100ba.cat”

NextReport=10/3/2005 1:17:10 PM

Confirmed=None

Reported=None

Unreported=Add

FullPath=“C:\Documents and Settings\Bill\100 files\e100ba.cat”

In one implementation, the scanning module 112 detects that a file on the synchronization client has changed, generates and schedules a synchronization report for that file, and transfers the synchronization report to the synchronization server 108 -at the appropriate time. In one implementation, the transfer may be accomplished by a transmission from the client to the server over a communications network. However, other implementations may transfer the synchronization report via an intermediary, such as a shared storage location, or by having the report read from the client by the server.

Upon receipt of a synchronization report for a file, the synchronization server 108 checks to determine the state of the file within its own files system. If the synchronization server 108 needs to receive the file from the client in order to synchronize with the client, the synchronization server 108 request that the client upload the file to the server. An update module 118 uploads the requested file to the synchronization server 108 (see synchronizing files 120). Alternatively, if the synchronization server 108 determines a conflict (e.g., the client file is edited and the server file is also edited), the synchronization server 108 executes a conflict resolution (e.g., asking the user to chose which version of the file to record at both the client and the server). Upon synchronizing the file with the synchronization client 106, the synchronization server 108 transmits a synchronization confirmation to inform the synchronization client 106 that the synchronization is complete. Note: If there is an error in the synchronization, the synchronization confirmation can also be used to indicate this to the synchronization client 106.

It should be understood that, in one implementation, the synchronization server 108 also includes a scanning module, which detects changes within the synchronization server's file system and issues the server's synchronization report to the appropriate synchronization client(s). Also, in the same implementation or in an alternative implementation, the synchronization server 108 includes an updating module, which responds to requests from synchronization clients for synchronizing files from the synchronization server 108.

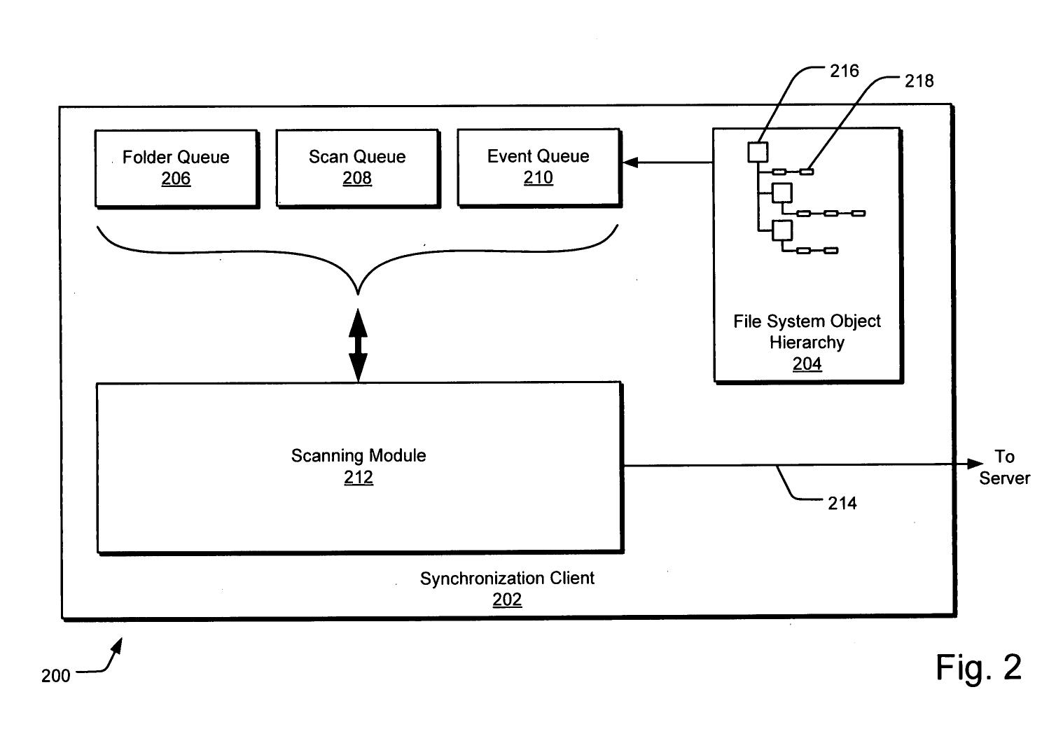

In one implementation, the scanning module 112 maintains three queues in the synchronization client 106: a folder queue, a scan queue, and an event queue (see e.g., FIG. 2). The scanning module 112 scans the queues for synchronization states that need reported and schedules such reports according to a scheduling scheme. In this manner, synchronization reports can be transferred to the synchronization server 108 with some consideration of processing usage, bandwidth usage, and synchronization integrity. It should be understood that other queue configurations may also be employed, including high/low priority queuing, multi-server queuing, etc.

FIG. 2 illustrates an example architecture 200 for a synchronization client 202. The synchronization client 202 includes data storage managed via a file system (not shown). The synchronization client 202 also includes a hierarchy 204 of objects representing the state of files and folders within the file system. Each object maintains the state and other information for a given file or folder. The synchronization client 202 also maintains a folder queue 206, a scan queue 208, and an event queue 210.

During initialization, a scanning module 212 places a root folder identifier object in the folder queue 206. Folder and file identifier objects indicate the path name of the folder or file identified by the object, so that the scanning module 212 can find the folder or file in the file system. The scanning module 212 then starts a recursive scan through the file system, starting with the root folder. For example, the scanning module 212 removes the root folder identifier object from the folder queue 206, creates a folder object in the hierarchy 204 see example folder object 216), and checks the file system location identified by the root folder identifier object to identify the folder's contents. Identifier objects for any contents are loaded into the appropriate queue (e.g., folder identifier objects in the folder queue 206 and file identifier objects in the scan queue 208). These objects will be evaluated by the scanning module 212 in subsequent stages of the recursive scan. Accordingly, after completing processing on the root folder, the scanning module 212 pulls the first file identifier object from the scan queue 208, creates a file object in the hierarchy 204 (see example file object 218), and schedules a synchronization report transmission to the synchronization server (see communications channel 214) for the associated file. The file identifier objects in the scan queue 208 are removed and processed before the scanning module 212 proceeds to the next folder identifier object on the folder queue 206. In one implementation, the recursion is performed in discrete stages of a number of folders/files, with managed delays in-between, in order to avoid monopolizing the system processor and storage subsystem during initialization. For example, managed delays introduced by the synchronization client may include waiting for system idle time or waiting a predetermined amount of time. In an alternative implementation, the synchronization server can manage the delays. For example, the synchronization server can specify to the client a number of synchronization reports it wants to receive in one cycle, await receipt of that many synchronization reports, and then delay before asking for the next set of synchronization reports. The scan processing proceeds recursively until the folder queue 206 and the scan queue 208 are empty.

When building the hierarchy 204, the scanning module 212 monitors file change events (e.g., file added, file deleted, file edited) through a file system watcher function. In one implementation, the file system watcher function hooks file change events to detect a change in the file system as the change is made. When a file system change event occurs, the file system watcher function identifies the changed file to the scanning module 212. In an alternative implementation, the file system watcher function scans the file system periodically to detect changes. In yet another implementation, the file system watcher function may be triggered by the user to scan the file system.

When a file system change is discovered for a file, the scanning module 212 creates a file identifier object associated with the change and adds the object to the event queue. In contrast, if the file system change is discovered for a folder, the scanning module 212 creates a folder identifier object associated with the change and adds the object to the folder queue. In this manner, file or folder identifier objects are added to the queues whenever file change events are detected.

Note: elements (e.g., file objects or folder objects) in the event queue 210 are processed at a higher priority than folders in the folder queue 208 or files in the scan queue to allow the scanning module 212 to process managed file system changes in the synchronization client 202 in a timely manner. Accordingly, the scanning module 212 checks the event queue 210 before selecting an element from the folder queue 206 or scan queue 208. It should be understood, however, that other priorities may be attributed to these or other queues.

When an event is pulled from the event queue 210, the scanning module 212 examines the corresponding file or folder in the file system of the synchronization client 202. If the element represents a file and the scanning module 212 determines that the file in the file system has been changed (e.g., added, deleted, edited), the scanning module 212 sets the Unreported state field to reflect the change and schedules a report indicating the change to the synchronization server. When the report is actually transferred to the synchronization server, the Unreported state field is set to none and the Reported state field is set to reflect the change.

When the synchronization server receives the report, the server compares the reported change to the state of the corresponding file within its own file system. If the states are not the same, a conflict resolution or a file upload is then executed to complete the synchronization. The synchronization server then sends back to the synchronization client 202 a confirmation of the synchronization, at which point the synchronization client 202 sets the Reported state field to none and the Confirmed state field to reflect the file change. Note: The scanning module 212 may recheck the Reported state at some later point in time to determine whether the report should be retransferred (e.g., retransmitted, etc.).

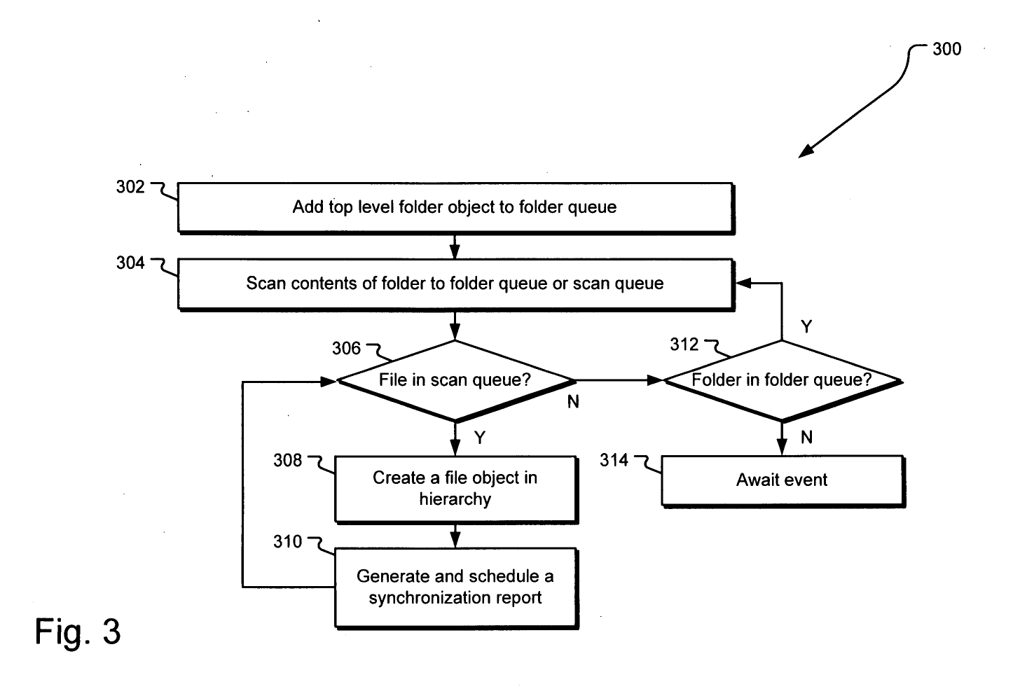

FIG. 3 illustrates example operations 300 for populating a file system object hierarchy. A root operation 302 adds a top level or root folder identifier object to the folder queue. A scan operation 304 takes the next folder identifier object from the folder queue, creates a corresponding folder object in the hierarchy, and scans individual identifier objects of contents into either the scan queue or the folder queue, depending on whether an element is a file or a folder.

Thereafter, a decision operation 306 determines whether there is a file identifier object in the scan queue. If so, a hierarchy operation 308 checks the file system location indicated by the object and creates a file object in the hierarchy. A scheduling operation 310 generates and schedules a synchronization report associated with the file for transmission to the synchronization server. Processing then returns for the decision operation 306.

If there is no file identifier object in the scan queue, a decision operation 312 determines whether there is a next folder identifier object in the folder queue. If so, processing returns to the scan operation 304, which scans the contents of the folder. Processing continues to execute recursively, until the decision operation 312 determines that no additional folders exist to be scanned, at which point, a waiting operation 314 awaits a file change event.

It should be understood that delays may be injected into the recursive processing of the file system hierarchy to manage processor usage, network bandwidth, and storage access. Furthermore, events may interrupt the processing of the folder and scan queues. In one implementation, events are processed at a higher priority than the folder or scan queues.

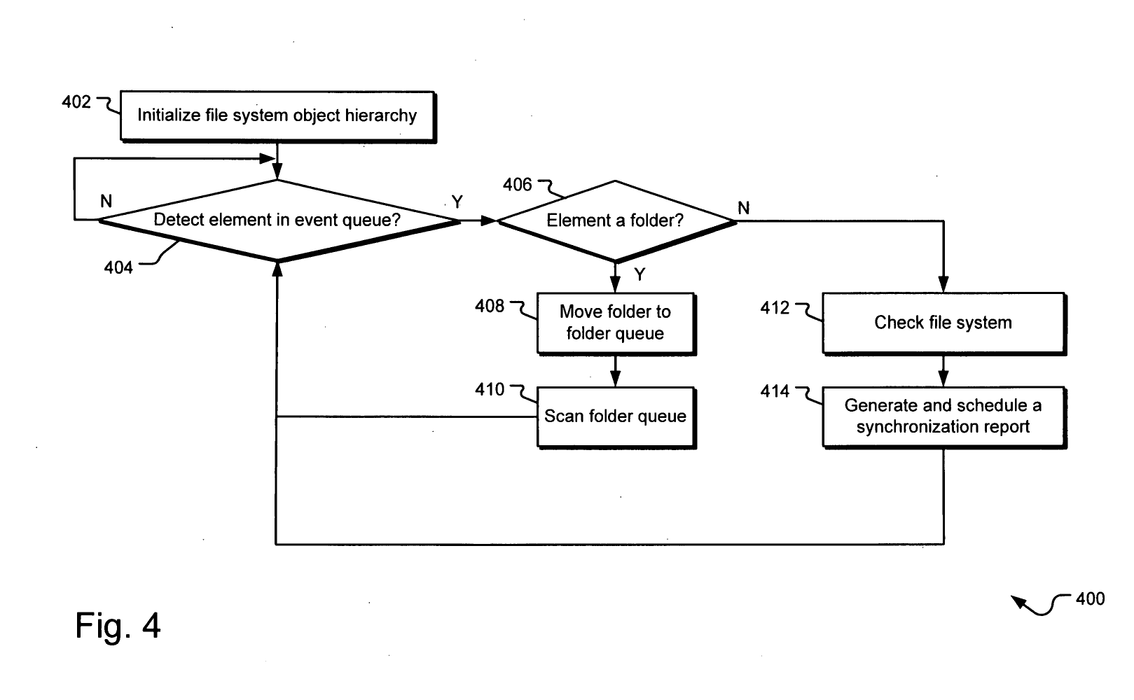

FIG. 4 illustrates example operations 400 for handling file change events. An initialization operation 402 initializes the file system object hierarchy. It should be understood that this initialization operation 402 could be interrupted by a detected event at anytime (and re-initiated at another time); however, for the description of FIG. 4, it is assumed that the file system hierarchy has completed the initialization stage at the completion of the initialization operation 402. A decision operation 404 awaits detection of an element to be available in the event queue (such as a identifier object being placed in the event queue in response to detection of a file change event by the file system watcher function), at which time a decision operation 406 determines whether the element referenced in the event queue is a folder identifier object or a file identifier object. If the element is a folder, the folder identifier object is placed in the folder queue in a move operation 408 and the folder queue is recursively scanned in a scan operation 410, such as was described with regard to FIG. 3. Processing then returns to the decision operation 404 to wait for another element to be available in the event queue by the file system watcher function.

In an alternative implementation, if no elements are available in the event queue, processing can check for file in the scan queue or the folder queue (potentially in that order). In this manner, the synchronization client can prioritize file change events over scanning results, so as to maintain tight synchronization between the synchronization client and the synchronization server.

However, if the element is a file, a checking operation 412 evaluates the file located at the path specified by the file identifier object and compares the state of that file (as indicated by the file system) with the state identified in the file object in the hierarchy. Depending on the respective states, a scheduling operation 414 generates a synchronization report responsive to the file change event and schedule transmission of the synchronization report to the synchronization server. Processing then returns to the decision operation 404 to wait for another element to be available in the event queue by the file system watcher function.

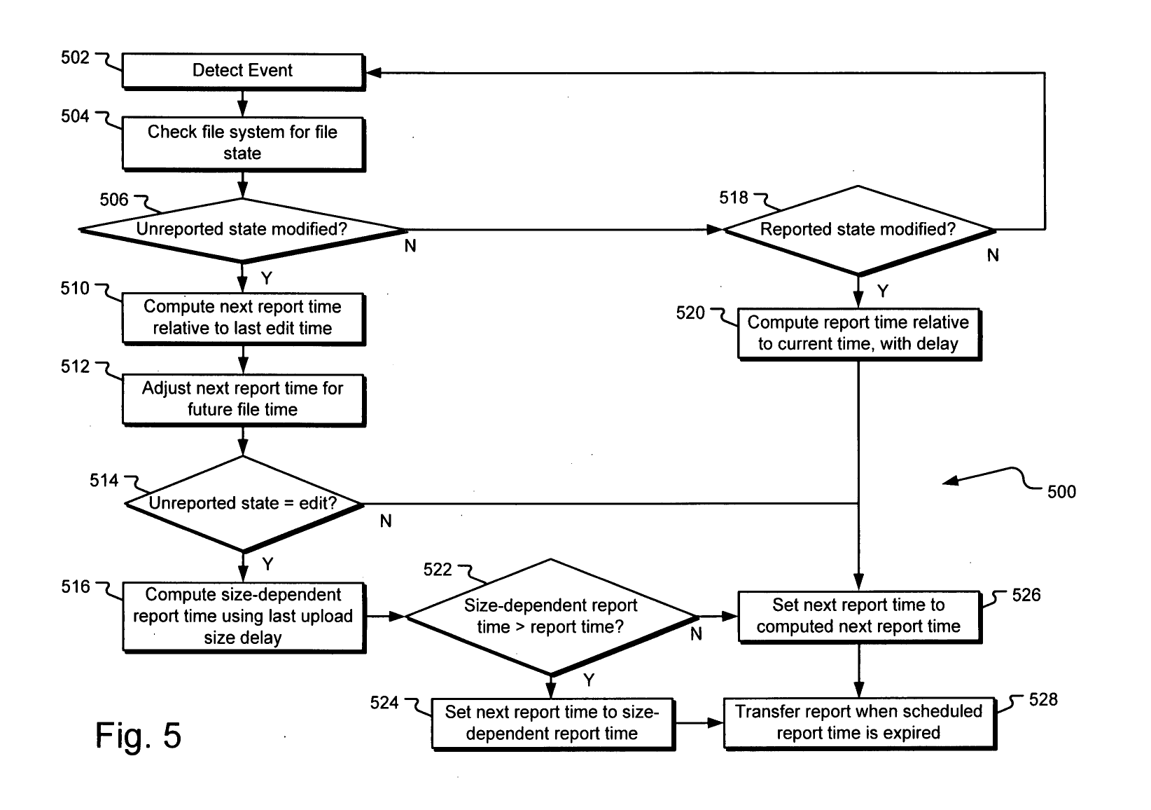

FIG. 5 illustrates example operations 500 for scheduling transmission of a synchronization report. A detection operation 502 detects an event (e.g., a file system watcher function places a file identifier object into the event queue). A checking operation 504 evaluates the file located at the path specified by the file identifier object and compares the state of that file (as indicated by the file system) with the state identified in the file object in the hierarchy.

A decision operation 506 determines whether the Unreported state of the corresponding file is modified (e.g., add, delete, edit). If so, a computing operation 510 computes a next report time relative to the last file change time (e.g., set the next report time equal to the last file change time plus 10 seconds). An adjustment operation 512 adjusts the next report time to within a future threshold of time (e.g., if the next report time is set for more than 30 seconds in the future, set the next report time to the current time, potentially determined from the system or network clock). Another decision operation 514 determines whether the Unreported state is an edit state. If so, an upload-size-dependent next report time is computed (e.g., the amount of time the upload last took at some reasonable communications channel transfer rate) and added to the last upload time. As determined in a decision operation 522, if the upload-size-dependent next report time exceeds the computed next report time, then the computed next report time is set to equal the upload-size-dependent next report time in a replacement operation 524. If the decision operation 522 determines that the upload-size-dependent next report time does not exceed the computed next report time, then the next report time is used in setting operation 526.

If the decision operation 506 determined that the Unreported state was not a modified state, another decision operation 518 determines whether the Reported state was a modified state, potentially indicated a previous failure of communication between the server and the client (e.g., a previously sent synchronization report was never received by the server). As such, a next report time is re-computed in a computing operation 520 to allow the synchronization report to be resent at an effective interval. Processing then proceeds to the setting operation 526.

Whether the scheduled next report time is set by the computed next report time or the upload-size-dependent next report time, the next report time is set in the file object in the file system hierarchy. When the next report time expires (e.g., the next report time is less than or equal to the current time determined by the client), the synchronization report is transferred to the synchronization server in a transferring operation 528.

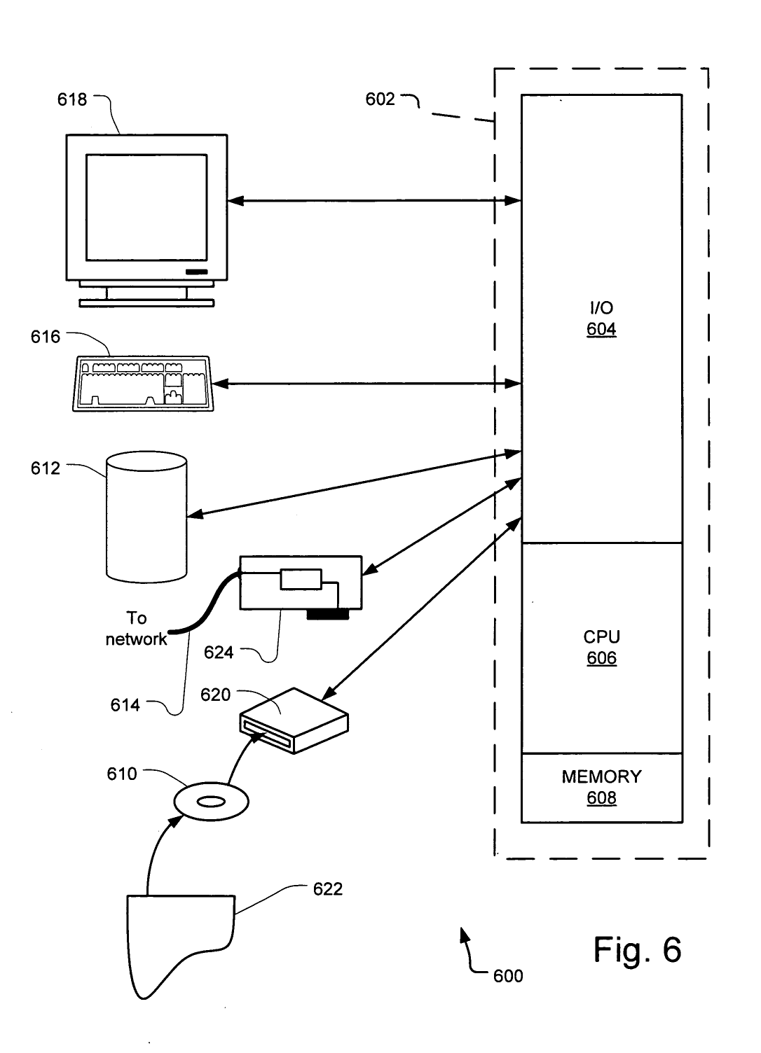

FIG. 6 illustrates an exemplary system useful in implementations of the described technology. A general purpose computer system 600 is capable of executing a computer program product to execute a computer process. Data and program files may be input to the computer system 600, which reads the files and executes the programs therein. Some of the elements of a general purpose computer system 600 are shown in FIG. 6 wherein a processor 602 is shown having an input/output (I/O) section 604, a Central Processing Unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a distributed computer, or any other type of computer. The described technology is optionally implemented in software devices loaded in memory 608, stored on a configured DVD/CD-ROM 610 or storage unit 612, and/or communicated via a wired or wireless network link 614 on a carrier signal, thereby transforming the computer system 600 in FIG. 6 to a special purpose machine for implementing the described operations.

The I/O section 604 is connected to one or more user-interface devices (e.g., a keyboard 616 and a display unit 618), a disk storage unit 612, and a disk drive unit 620. Generally, in contemporary systems, the disk drive unit 620 is a DVD/CD-ROM drive unit capable of reading the DVD/CD-ROM medium 610, which typically contains programs and data 622. Computer program products containing mechanisms to effectuate the systems and methods in accordance with the described technology may reside in the memory section 604, on a disk storage unit 612, or on the DVD/CD-ROM medium 610 of such a system 600. Alternatively, a disk drive unit 620 may be replaced or supplemented by a floppy drive unit, a tape drive unit, or other storage medium drive unit. The network adapter 624 is capable of connecting the computer system to a network via the network link 614, through which the computer system can receive instructions and data embodied in a carrier wave. Examples of such systems include SPARC systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as Personal Digital Assistants (PDAs), mobile phones, gaming consoles, set top boxes, etc.

When used in a LAN-networking environment, the computer system 600 is connected (by wired connection or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are exemplary and other means of and communications devices for establishing a communications link between the computers may be used.

In an exemplary implementation, scanning modules, update modules, and other modules may be incorporated as part of the operating system, application programs, or other program modules. File system hierarchies, scan queues, folder queues, event queues, schedule times, file objects, folder objects, and other data may be stored as program data.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter.

What is claimed is:

1. A method comprising:
detecting a change of state of a file in a file system of a client device;
generating a synchronization report that identifies the file and the change in the state of the file;
scheduling a report time at which a synchronization report is to be transferred to a server device;
transferring the synchronization report to the server device in accordance with the report time.

2. The method of claim 1 further comprising:
receiving at the client device a request from the server device for an upload of the file to the server device, responsive to receipt of the synchronization report by the server.

3. The method of claim 1 wherein the transferring operation comprises:
transferring the synchronization report to the server device, when the scheduled report time is earlier than or equal to a current time determined by the client device.

4. The method of claim 1 wherein the scheduling operation comprises:
setting the report time to be subsequent to a previous file change time for the file plus a designated amount of time.

5. The method of claim 1 wherein the scheduling operation comprises:
setting the report time to be subsequent to a previous upload change time for the file plus a designated amount of time.

6. The method of claim 5 wherein the designated amount of time is dependent upon an amount of data transferred during a previous upload operation associated with the file.

7. The method of claim 1 wherein the scheduling operation comprises:
setting the report time to be subsequent to a previous report time for the file plus a designated amount of time.

8. The method of claim 1 wherein the scheduling operation comprises:
adjusting the report time to an earlier time if the previous file change time associated with the file is greater than the current time by a designated amount of time.

9. A computer-readable medium having computer-executable instructions for performing a computer process, the computer process comprising:
detecting a change of state of a file in a file system of a client device;
generating a synchronization report that identifies the file and the change in the state of the file;
scheduling a report time at which a synchronization report is to be transferred to a server device;
transferring the synchronization report to the server device in accordance with the report time.

10. The computer-readable medium of claim 9 wherein the computer process further comprising:
receiving at the client device a request from the server device for an upload of the file to the server device, responsive to receipt of the synchronization report by the server.

11. The computer-readable medium of claim 9 wherein the transmitting operation comprises:
transmitting the synchronization report to the server device, when the scheduled report time is earlier than or equal to a current time determined by the client device.

12. The computer-readable medium of claim 9 wherein the scheduling operation comprises:
setting the report time to be subsequent to a previous file change time for the file plus a designated amount of time.

13. The computer-readable medium of claim 9 wherein the scheduling operation comprises:
setting the report time to be subsequent to a previous upload change time for the file plus a designated amount of time.

14. The computer-readable medium of claim 13 wherein the designated amount of time is dependent upon an amount of data transferred during a previous upload operation associated with the file.

15. The computer-readable medium of claim 9 wherein the scheduling operation comprises:
setting the report time to be subsequent to a previous report time for the file plus a designated amount of time.

16. The computer-readable medium of claim 9 wherein the computer process further comprises:
maintaining a scan queue that references one or more files encountered during a scan by the client device through the file system and an event queue that references one or more files associated with a file change event detected by the client device;
wherein the detecting operation comprises:
examining a reference in the event queue at a higher priority than a reference in the scan queue.

17. A method comprising:
generating a file system hierarchy based on scanning at least one of a folder queue identifier one or more folders in the file system a scan queue identifying one or more files in the file system, or an event queue identifying one or more files associated with a file state change in the file system;
identifying a file associated with a change of state by extracting a first element from the event queue;
generating a synchronization report that identifies the file and the change in the state of the file;
transferring the synchronization report to the server device.

18. The method of claim 17 further comprising:
scheduling a report time at which a synchronization report is to be transferred to a server device.

19. The method of claim 18 wherein the transferring operation comprises:
transferring the synchronization report to the server device when the report time expires.

20. A computer-readable medium having computer-executable instructions for performing a computer process that implements the operations recited in claim 17.
